(19) United States
(12) Patent Application Publication
(10) Pub. No.: US 2009/0285389 A1
(43) Pub. Date: Nov. 19, 2009

(54) ELECTRONIC CERTIFICATION SYSTEM AND CONFIDENTIAL COMMUNICATION SYSTEM

(75) Inventor: Masakatsu Matsuo, Fukuoka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/464,436

(22) Filed: May 12, 2009

(30) Foreign Application Priority Data
May 13, 2008 (JP) 2008-125662

(51) Int. Cl. H04L 9/30; H04L 9/32

(52) U.S. Cl. 380/30; 713/156

(57) ABSTRACT

A first apparatus as a requester is configured to encrypt random number data by using a public key of a second apparatus as a certificate issuer; to perform a calculation that multiples original data by the obtained encrypted random number data; and to deliver the obtained random number scrambled original data to the second apparatus. The second apparatus is configured to perform a calculation that multiples the random number scrambled original data by certified item data; to encrypt the obtained random number scrambled original data having the certified item, using a private key of the second apparatus; and to issue the obtained certificate data to one of the first apparatus and another apparatus that performs verification.

### CROSS-REFERENCE TO RELATED APPLICATIONS

The present application claims priority under 35 U.S.C. §119 of Japanese Application No. 2008-125662, filed on May 13, 2008, the disclosure of which is expressly incorporated by reference herein in its entirety.

### BACKGROUND OF THE INVENTION

1. Field of the Invention

The present invention relates to an electronic certification system that allows a certifier to issue a certificate while contents of original data is kept confidential. The present invention also relates to a confidential communication system that transmits notification data from a notifying apparatus to a notified apparatus while others are kept from knowing the data.

2. Description of Related Art

In recent years, there is a rising demand for systems that issue various certificates to electronic data. As an example of the certificate issuing system for such electronic data, a technology is known that issues time stamps (time certificates) adding time information to electronic data.

In addition, as a known technology related to maintaining confidentiality of original data toward a certifier issuing various certificates for electronic data, there is blind signature technology that allows a signer to sign while contents of the original is kept confidential (see Related Art 1).

[Related Art 1] U.S. Pat. No. 4,759,063

However, with the conventional blind signature technology, it is impossible to add certified item data that describes various certified items. Therefore, the blind signature technology cannot be applied to the electronic certification system as is. Further, the conventional time stamp technology guarantees identity of the original data by matching hash values. While the hash value matching indicates high probability of the original being identical, however, it does not guarantee the absolute matching. Therefore, a system is desired that can add certified item data to the original data itself and guarantees the identity of the original data at a higher level. In addition, adding certified item data to the original data itself may become a burden on the operating system and increase cost, when the process is complicated. Therefore, it is desired to create a system that can decrease the burden on the operating system.

### SUMMARY OF THE INVENTION

The present invention is provided to address the above-described problems. An advantage of an embodiment of the present invention is to provide an electronic certification system configured to maintain confidentiality of original data while guaranteeing identity of the original data at a high level and decreasing the operational burden. Another advantage of an embodiment of the present invention is to provide a confidential communication system that utilizes the above-described electronic certification system technology and transmits notification data from a notifying apparatus to a notified apparatus, while others are kept from knowing the data.

According to the electronic certification system of the present invention, the system having a first apparatus configured as a requester and a second apparatus configured as a certificate issuer includes: the first apparatus configured to encrypt random number data by using a public key of the second apparatus; to perform a calculation that multiples original data by the obtained encrypted random number data; and to deliver the obtained random number scrambled original data to the second apparatus; and, the second apparatus configured to perform a calculation that multiples the random number scrambled original data received from the first apparatus by certified item data; to encrypt the obtained random number scrambled original data having the certified item, using a private key of the second apparatus; and to issue the obtained certificate data to one of the first apparatus and another apparatus.

Further, according to the confidential communication system according to the present invention, the system having a first apparatus configured as a communication destination and a second apparatus configured as a communication source includes: the first apparatus configured to encrypt random number data by using a public key of the second apparatus; and to deliver the obtained encrypted random number data to the second apparatus; the second apparatus configured to perform a calculation that multiples notification data by the encrypted random number data received from the first apparatus; to encrypt the obtained random number scrambled notification data, by using a private key of the second apparatus, and to obtain encrypted notification data; and to deliver the encrypted notification data to the first apparatus; and the first apparatus further configured to perform a calculation that multiplies the encrypted notification data received from the second apparatus by an inverse number of the random number data, and to remove the random number data from the encrypted notification data; and to obtain notification data by decrypting the obtained data by using the public key of the second apparatus.

According to the present invention, the original data is delivered to the second apparatus (certificate issuer) while the data is being scrambled by the random number. Therefore, the second apparatus cannot know the contents of the original data, thereby securing the confidentiality of the original data. In addition, the certificate data is generated while the original data is included. Therefore, it is possible to guarantee the identity of the original data at a high level. Furthermore, the calculation is performed only by encryption and multiplication, thereby decreasing the operational burden.

As a first aspect of the present invention provided to address the above-described problem, the aspect having a first apparatus configured as a requester and a second apparatus configured as a certificate issuer includes: the first apparatus configured to encrypt random number data by using a public key of the second apparatus; to perform a calculation that multiples original data by the obtained encrypted random number data; and to deliver the obtained random number scrambled original data to the second apparatus; and, the second apparatus configured to perform a calculation that multiples the random number scrambled original data received from the first apparatus by certified item data; to encrypt the obtained random number scrambled original data having the certified item, using a private key of the second apparatus; and to issue the obtained certificate data to one of the first apparatus and another apparatus.

Accordingly, the original data is delivered to the second apparatus (certificate issuer) while the data is being scrambled by the random number. Therefore, the second apparatus cannot know the contents of the original data, thereby securing the confidentiality of the original data. In addition, the certificate data is generated while the original data is included. Therefore, it is possible to guarantee the identity of the original data at a high level. Furthermore, the calculation is performed only by encryption and multiplication, thereby decreasing the operational burden.

As a second aspect of the present invention provided to address the above-described problem, according to the first aspect of the present invention, one of the first apparatus and the another apparatus is configured to perform a calculation that multiples the certificate data by an inverse number of the random number data, and to remove the random number data from the certificate data; to decrypt the obtained data by using the public key of the second apparatus; to obtain product data that is a multiplication of the original data and the certified item data; and to obtain certified item data by multiplying the product data by an inverse number of the original data.

Accordingly, through the use of the original data, it is possible to know the contents of the certified item data added to the original data by the second apparatus.

Further, the series of the processes performed by one of the first apparatus and the another apparatus is not limited to processes be performed entirely only by one apparatus. A plurality of the apparatuses may be assigned to perform the processes.

As a third aspect of the present invention provided to address the above-described problem, according to the first aspect of the present invention, one of the first apparatus and the another apparatus is configured to obtain the certified item data; to perform a calculation that multiples the certificate data by the inverse number of the random number data, and to remove the random number data from the certificate data; to decrypt the obtained data by using the public key of the second apparatus; to obtain product data that is a multiplication of the original data and the certified item data; and to multiply the product data by an inverse number of the certified item data, and to obtain the original data.

Accordingly, through the use of the certified item data, it is possible to know the contents of the original data to which the certified item data is added.

Further, the series of the processes performed by one of the first apparatus and the another apparatus is not limited to processes to be performed entirely only by one apparatus. A plurality of the apparatuses may be assigned to perform the processes.

In this example, the method for obtaining the certified item data by one of the first apparatus and the another apparatus is not specified. However, the certified item data can be obtained either by one of the first apparatus and the another apparatus according to the third aspect of the invention, or directly by the second apparatus.

As a fourth aspect of the present invention provided to address the above-described problem, according to the first aspect of the present invention, the second apparatus is configured to encrypt the certified item data by using the private key of the second apparatus; and one of the first apparatus and the another apparatus is configured to obtain one of the obtained encrypted certified item data and an inverse number of the encrypted certified item data; to perform a calculation that multiplies the certificate data by the inverse number of the random number data or by the inverse number of the encrypted certified item data, and to obtain encrypted original data; and to decrypt the encrypted original data by using the public key of the second apparatus, and to obtain the original data.

Accordingly, through the use of the encrypted certified item data generated by the second apparatus, it is possible to know the contents of the original data to which the certified item data is added. Since the encrypted certified item data can be decrypted by the public key, it is the same as knowing the contents of the original data to which the certified item data is added.

Further, the series of the processes performed by one of the first apparatus and the another apparatus is not limited to processes to be performed entirely only by one apparatus. A plurality of the apparatuses may be assigned to perform the processes.

As a fifth aspect of the present invention provided to address the above-described problem, according to the first aspect of the present invention, the certified item data includes time information.

Accordingly, the certificate data becomes a time stamp (time certification) that certifies that the original data has surely been present at the indicated time.

As a sixth aspect of the present invention provided to address the above-described problem, according to the first aspect of the present invention, each process is performed while the original data is split into a plurality of spilt data sets.

Accordingly, it is possible to decrease the operational burden at each process. In case of ultimately browsing the original data, the split data can be integrated together. The process that involves splitting and integrating can largely decrease the operational amount, compared to when the encrypting, decrypting, and multiplication are performed without splitting.

As a seventh aspect of the present invention provided to address the above-described problem, the aspect having a first apparatus configured as a communication destination and second apparatus configured as a communication source includes: the first apparatus configured to encrypt random number data by using a public key of the second apparatus; and to deliver the obtained encrypted random number data to the second apparatus; the second apparatus configured to perform a calculation that multiples notification data for confidential communication by the encrypted random number data received from the first apparatus; to encrypt the obtained random number scrambled notification data, by using a private key of the second apparatus, and to obtain encrypted notification data; and to deliver the encrypted notification data to the first apparatus; and the first apparatus further configured to perform a calculation that multiplies the encrypted notification data received from the second apparatus by an inverse number of the random number data, and to remove the random number data from the encrypted notification data; and to obtain notification data by decrypting the obtained data by using the public key of the second apparatus.

Accordingly, it is impossible to obtain the random number data without having the private key of the second apparatus, from the encrypted random number data sent from the first apparatus (communication destination) to the second apparatus (communication source). Additionally, it is impossible to obtain the notification data without knowing the random number data generated by the first apparatus, from the encrypted notification data sent from the second apparatus to the first apparatus. Therefore, it is possible to maintain the high confidentiality level.

As an eighth aspect of the present invention provided to address the above-described problem, according to the seventh aspect of the present invention, each process is performed while the notification data is split into a plurality of spilt data sets.

Accordingly, it is possible to decrease the operational burden at each process. In case of ultimately browsing the original data, the split data can be integrated together. The process that involves splitting and integrating can largely decrease the operational amount, compared to when the encrypting, decrypting, and multiplication are performed without splitting.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a system configuration diagram illustrating an electronic certification system according to the present invention;

FIG. 2 is a block chart illustrating a first example of each of the first through the third apparatuses shown in FIG. 1;

FIG. 3 is a block chart illustrating a second example of each of the first through the third apparatuses shown in FIG. 1;

FIG. 4 is a block chart illustrating a third example of each of the first through the third apparatuses shown in FIG. 1;

FIG. 5 is a system configuration diagram illustrating a confidential communication system according to the present invention; and

FIG. 6 is a block chart illustrating an example of each of the first and the second apparatuses shown in FIG. 5.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

Embodiments of the present invention are illustrated as follows with reference to the drawings.

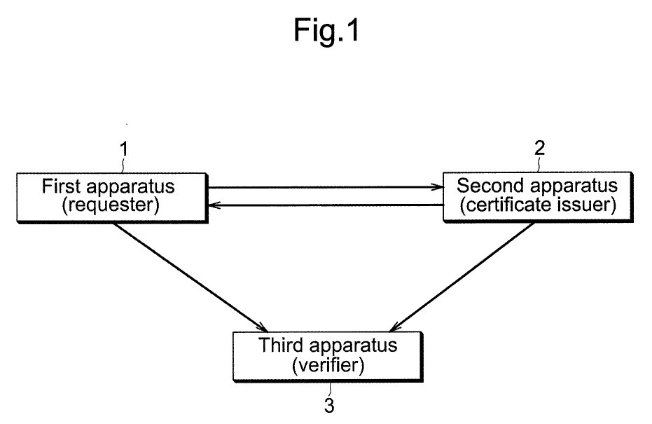

FIG. 1 is a system configuration diagram illustrating an electronic certification system according to the present invention. In the electronic certification system, first apparatus 1 (requester) transmits a request. Based on the request, second apparatus 2 (certificate issuer) then issues various certificates for time certifications (e.g., time stamps). Third apparatus 3 performs verification based on the certificates.

In this example, third apparatus 3 performs the verification which is a separate apparatus from first apparatus 1 (requester). However, it is possible for first apparatus 1 to perform the verification. In this case, first apparatus 1 is combined with third apparatus 3.

The original data is split into a plurality of split data sets with an appropriate data amount, and individually processed by first through third apparatuses 1-3 as illustrated below.

### First Embodiment

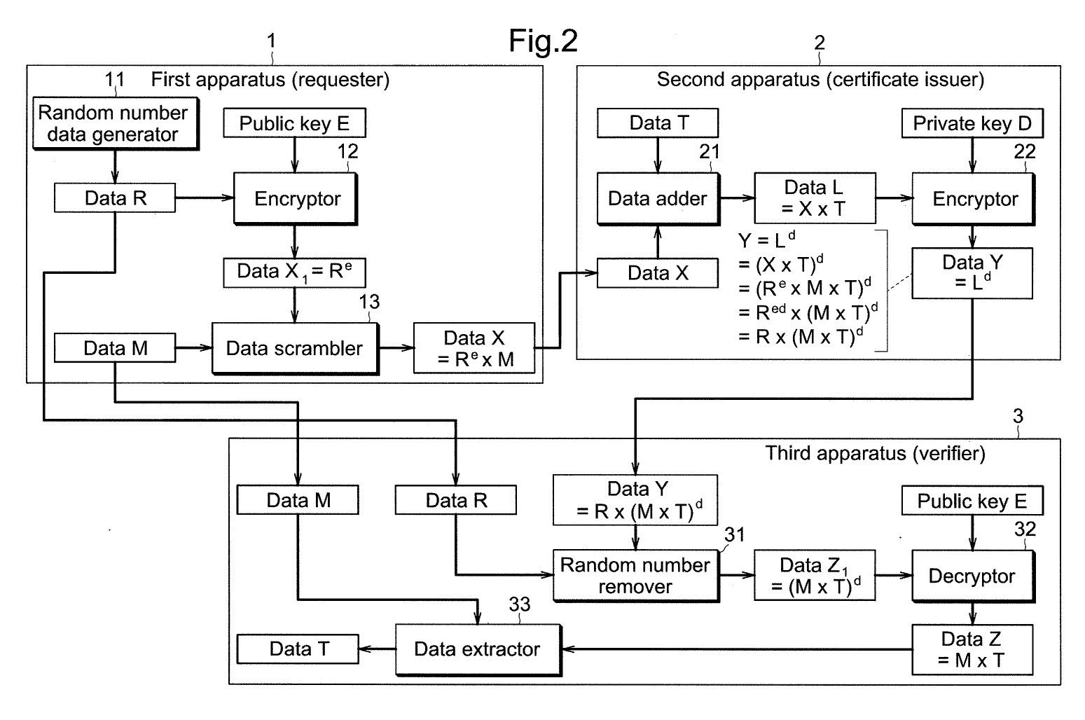

FIG. 2 is a block chart illustrating a first example of each of the first through the third apparatuses shown in FIG. 1. First apparatus 1 (requester) includes random number generator 11, encryptor 12, and data scrambler 13. Random number generator 11 generates random number data R. Encryptor 12 encrypts random number data R generated by random number generator 11. Data scrambler 13 scrambles original data M by using encrypted random number data XI obtained by encryptor 12. The random number scrambled original data X obtained by data scrambler 13 is transmitted to second apparatus 2.

Encryptor 12 encrypts random number data R by using public key E (e, N) of second apparatus 2. Encrypted random number data X₁ obtained here is as follows. Additionally, residue system calculation is performed as follows.

X₁=R^{e} mod N (formula 1)

In drawings starting from FIG. 2, “mod N” indicating residue system calculation is omitted.

Data scrambler 13 performs calculation that multiplies encrypted random number data X₁ by original data M, data X₁ being obtained by encryptor 12. Random number scrambled original data X is obtained, succeeding formula 1, as follows:

$$\begin{matrix}X = ( {X}_{1} \times M ) mod N \\ = ( {R}^{e} \times M ) mod N\end{matrix} \qquad ( formula 2 )$$

Random number scrambled original data X is scrambled by random number data R. Therefore, original data M cannot be obtained without knowing random data R. In other words, all other apparatuses including second apparatus 2, but excluding first apparatus 1, are not informed of the contents of original data M if only formula 2 is just given. The user of first apparatus 1 only needs second apparatus 2 to certify that the original data M is valid, and does not wish to disclose the contents of original data M to second apparatus 2. Since first apparatus 1 (requester) has the above-described configuration, original data M is delivered to second apparatus 2 (certificate issuer) while original data M is scrambled by random number data R. Therefore, second apparatus 2 cannot know the contents of original data M, thereby maintaining confidentiality of original data M.

Second apparatus 2 (certificate issuer) includes data adder 21 and encryptor 22. Data adder 21 adds certified item data T to random number scrambled original data X received from first apparatus 1. Encryptor 22 encrypts random number scrambled original data having certified item L (=X×T) obtained by data adder 21. Certificate data Y (=L^{d}) obtained here is issued to first apparatus 1 or third apparatus 3.

When certified item data T includes current time information, it becomes a time stamp.

Data adder 21 performs calculation that multiples random number scrambled original data X by certified item data T. Random number scrambled original data having certified item L is obtained, succeeding formula 2, as follows:

$$\begin{matrix}L = ( X \times T ) mod N \\ = ( {R}^{e} \times M \times T ) mod N\end{matrix} \qquad ( formula 3 )$$

Encryptor 22 performs encryption (RSA encryption) on random number scrambled original data having certified item L using private key D (d, N) of its own apparatus. The certificate data Y is obtained, succeeding formula 3, as follows:

$$\begin{matrix}Y = {L}^{d} mod N \\ = {( {R}^{e} \times M \times T )}^{d} mod N \\ = {( {R}^{ed} \times M \times T )}^{d} mod N \\ = ( R \times {( M \times T )}^{d} ) mod N\end{matrix} \qquad ( formula 4 )$$

In this sate, random number data R that is encrypted by first apparatus 1 is restored, while product data M×T, which is multiplication of original data M and certified item data T, is encrypted by private key D (d, N). Even when there is public key E (e, N) of second apparatus 2, it is impossible to obtain original data M and certified item data T without knowing random number data R. However, certificate data Y is generated by including original data M, it is possible to guarantee the identity of original data M at a high level. The conventional time stamp technology can indicate high probability of the original data being identical, by matching the hash values. However, it cannot guarantee the absolute matching. In contrast, the configuration of the present embodiment can guarantee the identity of original data at a high level.

Third apparatus 3 receives original data M and random number data R from first apparatus 1, and receives certificate data Y directly from second apparatus 2 or via first apparatus 1.

Third apparatus 3 has random number remover 31, decryptor 32, and data extractor 33. Random number remover 31 removes random number data R from certificate data Y. Decryptor 32 decrypts data Z₁ obtained by random number remover 31. Data extractor 33 extracts certified item data T from data Z obtained by decryptor 32.

Random number remover 31 performs calculation that multiplies certificate data Y by inverse number R⁻¹ of random number data R. Data Z₁ is obtained, succeeding formula 4, as follows:

$$\begin{matrix}{Z}_{1} = ( Y \times {R}^{- 1} ) mod N \\ = ( R \times {( M \times T )}^{d} \times {R}^{- 1} ) mod N \\ = {( M \times T )}^{d} mod N\end{matrix} \qquad ( formula 5 )$$

In this state, product data M×T, which is multiplication of original data M and certified item data T, is encrypted by private key D (d, N) of second apparatus 2.

Decryptor 32 decrypts data Z₁ obtained by random number remover 31, by using public key E (e, N) of second apparatus 2. Data Z is obtained, succeeding formula 5, as follows, which is multiplication of original data M and certified item data T, i.e., product data M×T.

$$\begin{matrix}Z = {Z}_{1}^{2} mod N \\ = {( M \times T )}^{de} mod N \\ = ( M \times T ) mod N\end{matrix}$$

Data extractor 33 performs calculation that multiplies data Z obtained by decryptor 32, which is product data M×T, by inverse number M⁻¹ of original data M, in order to obtain certified item data T.

Since original data M is removed from data decrypted by public key E (e, N) of second apparatus 2, it is possible to regard that certified item data T obtained at this state is generated by second apparatus 2. Further, when invalid data is decrypted by public key E (e, N) of second apparatus 2, some data can be obtained by removing original data M therefrom. However, it does not make sense as certified item data T, thereby making it possible to determine that the data is invalid. Especially, when a standard format is applied to certified item data T, it is possible to simplify the detection of valid or invalid data.

Accordingly, through the use of original data M, third apparatus 3 can be informed of the contents of certified item data T added to original data M by second apparatus 2, thereby making it possible to verify certified item data T added to original data M by second apparatus 2.

In this example, third apparatus 3 performs removing of the random number. However, it is more practical and beneficial for a purpose of omitting the process of the random number management, that second apparatus 2 delivers certificate data Y to first apparatus 1 so that first apparatus 1 performs up to removing of the random number, and then, first apparatus 1 delivers (M×T)^{d} to third apparatus 3 (verifier).

### Second Embodiment

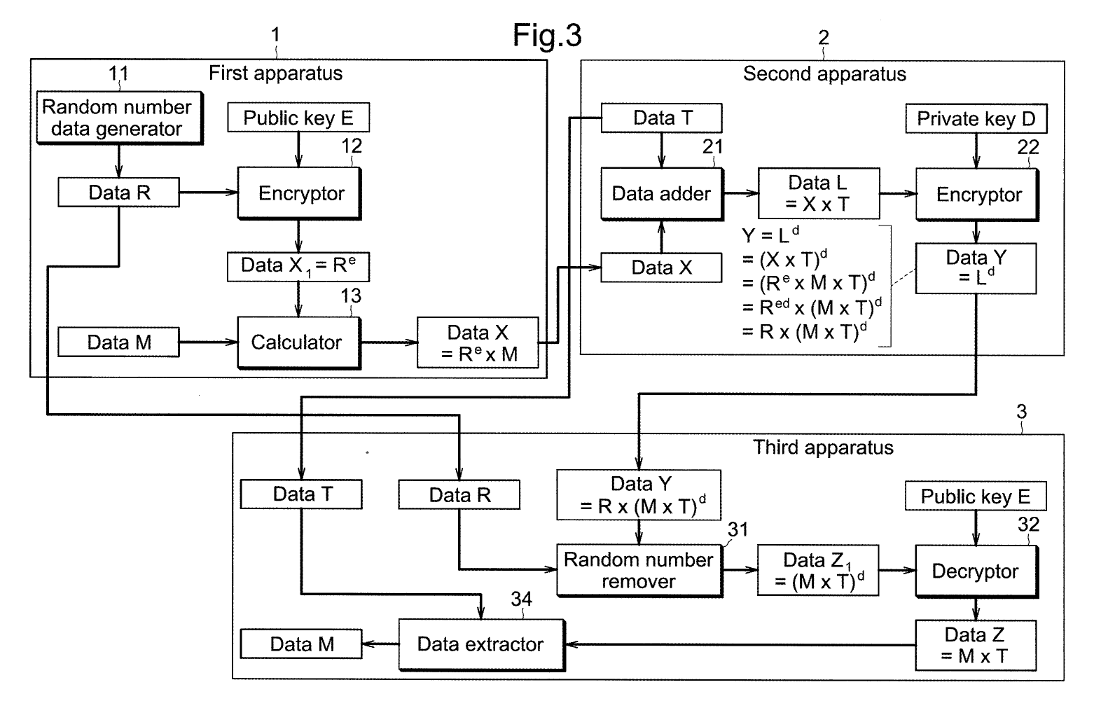

FIG. 3 is a block chart illustrating a second example of each of the first through the third apparatuses shown in FIG. 1. Configurations of first and second apparatuses 1 and 2, and the processing method of each data are basically the same as the first embodiment shown in FIG. 2. In the present embodiment, however, second apparatus 2 transmits, to first apparatus 1 or third apparatus 3, certified item data T or inverse number T⁻¹, along with certificate data Y.

Third apparatus 3 receives certified item data T or inverse number T⁻¹ directly from second apparatus 2, or via first apparatus 1. In third apparatus 3, data extractor 34 performs calculation that multiples data Z obtained by decryptor 32, i.e., product data M×T, by inverse number T⁻¹ of certified item data T received from second apparatus 2, in order to obtain original data M. Other configurations are similar to the example shown in FIG. 2. Accordingly, third apparatus 3, through the use of certified item data T, can be informed of the contents of original data M to which certified item data T is added, and verify original data M of certified item data T added by second apparatus 2.

In this example, third apparatus 3 performs removing of the random number. However, it is more practical and beneficial for a purpose of omitting the process of the random number management, that second apparatus 2 delivers certificate data Y to first apparatus 1 so that first apparatus 1 performs up to removing of the random number, and then, first apparatus I delivers (M×T)^{d} to third apparatus 3 (verifier).

### Third Embodiment

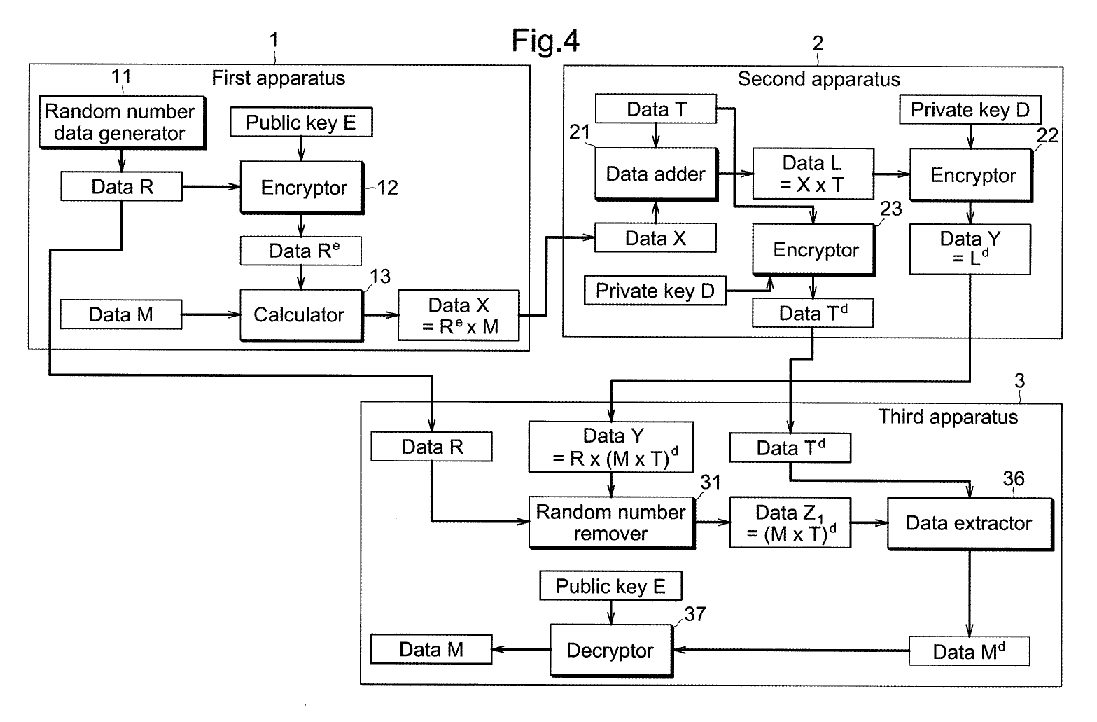

FIG. 4 is a block chart illustrating a third example of each of the first through the third apparatuses shown in FIG. 1. Configurations of first and second apparatuses 1 and 2, and the processing method of each data are basically the same as the first embodiment shown in FIG. 2. In the present embodiment, however, second apparatus 2 has encryptor 23 that encrypts certified item data T using private key D (d, N) of its own apparatus. Encrypted certified item data T^{d} or inverse number T^{-d} obtained here is transmitted, along with certificate data Y, to first apparatus 1 or third apparatus 3.

Third apparatus 3 receives encrypted certified item data T^{d} or inverse number T^{-d} directly from second apparatus 2 or via first apparatus 1. Third apparatus 3 has data extractor 36 and decryptor 37. Data extractor 36 removes encrypted certified item data T^{d} from data Z₁ obtained by random number remover 31, and transforms the data into data M^{d} only. Decryptor 37 decrypts data M^{d} obtained by data extractor 36.

Data extractor 36 performs calculation that multiplies data Z₁ obtained by random number remover 31 by inverse number T^{-d} of encrypted certified item data T^{d}. Data Z is obtained, succeeding formula 5, as follows:

$$\begin{matrix}Z = ( {Z}_{1} \times {T}^{- d} ) mod N \\ = ( {( M \times T )}^{d} \times {T}^{- d} ) mod N \\ = {M}^{d} mod N\end{matrix}$$

This shows original data M being encrypted by private key D (d, N) of second apparatus 2.

Decryptor 37 performs a decrypting process on data M^{d} obtained by data extractor 36, by using public key E (e, N) of second apparatus 2, and obtains original data M. Accordingly, it is possible, through the use of encrypted certified item data T^{d} generated by second apparatus 2, to be informed of the contents of original data M to which encrypted certified item data T^{d} is added, thereby making it possible to verify original data M of encrypted certified item data T^{d} added by second apparatus 2. In third apparatus 3, decryptor 37 can decrypt, similar to data M^{d}, encrypted certified item data T^{d} by using public key E (e, N) of second apparatus 2, and obtain certified item data T. Therefore, third apparatus 3 can verify original data M of certified item data T added by second apparatus 2. In other words, since encrypted certified item data T^{d} can be decrypted by public key E (e, N), it is the same as third apparatus 3 being informed of the contents of original data M to which certified item data T is added. With the above-described configuration, it is possible for third apparatus 3 to obtain and verify both original data M and certified item data T at the same time.

In this example, third apparatus 3 performs removing of the random number. However, it is more practical and beneficial for a purpose of omitting the process of the random number management, that second apparatus 2 delivers certificate data Y to first apparatus 1 so that first apparatus 1 performs up to removing of the random number, and then, first apparatus 1 delivers (M×T)^{d} to third apparatus 3 (verifier).

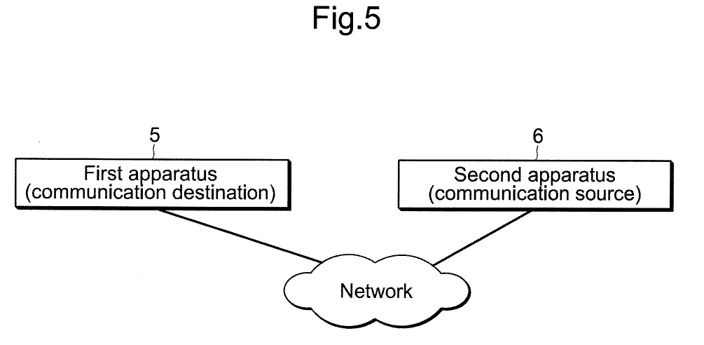

FIG. 5 is a system configuration diagram illustrating a confidential communication system according to the present invention. In the confidential communication system, first apparatus 5 (communication destination) and second apparatus 6 (communication source) are connected via a network. Notification data for confidential communication is transmitted from second apparatus 6 to first apparatus 5.

The notification data is divided into a plurality of divided data sets with an appropriate data amount, and individually processed by first apparatus 5 and second apparatus 6 as illustrated below.

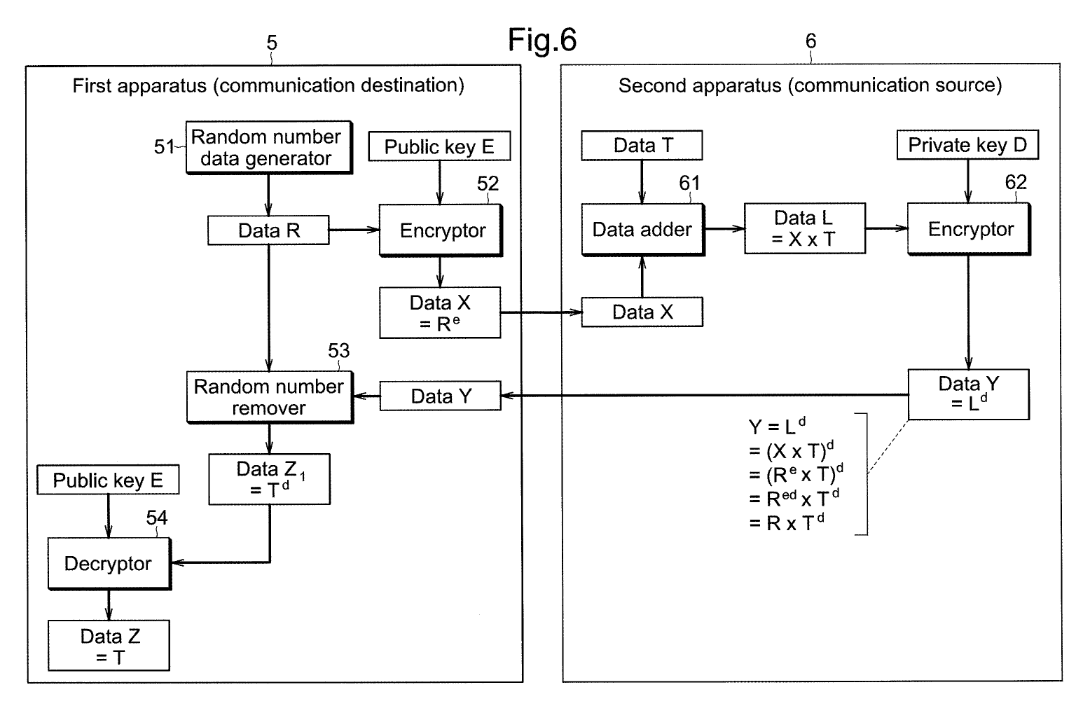

FIG. 6 is a block chart illustrating an example of each of the first and the second apparatuses shown in FIG. 5. First apparatus 5 (communication destination) has random number generator 51 and encryptor 52. Random number generator 51 generates random number data R, and encryptor 52 encrypts random number data R generated by random number generator 51. Encrypted random number data X obtained by encryptor 52 is transmitted to second apparatus 6.

Encryptor 52 encrypts random number data R by using public key E (e, N) of second apparatus 2. Encrypted random number data X is obtained as follows:

X=R^{e} mod N (formula 6)

Second apparatus 6 (communication source) has data adder 61 and encryptor 62. Data adder 61 adds notification data T to encrypted random number data X received from first apparatus 5. Encryptor 62 encrypts random number scrambled notification data L obtained by data adder 61. Encrypted notification data Y obtained here is transmitted to first apparatus 5.

Data adder 61 performs calculation that multiplies encrypted random number data X by notification data T. Random number scrambled notification data L is obtained, succeeding formula 6, as follows.

$$\begin{matrix}L = ( X \times T ) mod N \\ = ( {R}^{e} \times T ) mod N\end{matrix} \qquad ( formula 7 )$$

Encryptor 62 performs encryption (RSA encryption) of random number scrambled notification data L using private key D (d, N) of its own apparatus. Encrypted notification data Y is obtained, succeeding formula 7, as follows:

$$\begin{matrix}Y = {L}^{d} mod N \\ = {( {R}^{e} \times T )}^{d} mod N \\ = ( {R}^{ed} \times {T}^{d} ) mod N \\ = ( R \times {T}^{d} ) mod N\end{matrix} \qquad ( formula 8 )$$

Since encrypted notification data Y is scrambled by random number data R, it is impossible to obtain notification data T without knowing random number data R, even when there is public key E (e, N) of second apparatus 6. Therefore, even when there is an intermediary intervening in communication between second apparatus 6 and first apparatus 5, the person cannot know the contents of the communication.

First apparatus 5 further includes random number remover 53 and decryptor 54. Random number remover 53 removes random number data R from encrypted notification data Y received from second apparatus 6. Decryptor 54 decrypts data Z₁ obtained by random number remover 53.

Random number remover 53 performs calculation that multiples encrypted notification data Y by inverse number R⁻¹ of random number data R. Data Z₁ is obtained, succeeding formula 8, as follows:

$$\begin{matrix}{Z}_{1} = ( Y \times {R}^{- 1} ) mod N \\ = ( R \times {T}^{d} \times {R}^{- 1} ) mod N \\ = {T}^{d} mod N\end{matrix} \qquad ( formula 9 )$$

This formula shows notification data T being encrypted by private key D (d, N) of second apparatus 6.

Decryptor 54 decrypts Z₁ obtained by random number remover 53, by using public key E (e, N) of second apparatus 6 and obtains notification data T.

With the above-described configuration, it is impossible to obtain random number data R, without private key D (d, N) of second apparatus 6, from encrypted random number data X transmitted from first apparatus 5 (communication destination) to second apparatus 6 (communication source). Further, it is impossible to obtain notification data T, without knowing random number data R generated by first apparatus 5, from encrypted notification data Y transmitted from second apparatus 6 to first apparatus 5. Therefore, it is possible to maintain confidentiality at a high level.

An advantage of the electronic certification system according to the present invention is to guarantee identity of original data at a high level and decrease the operational burden, while maintaining confidentiality of the original data. Therefore, it is advantageous, for example, as an electronic certification system that enables a certifier to issue a certificate while maintaining the confidentiality of contents of the original data. Further, the confidential communication system according to the present invention is advantageous as a confidential communication system in which notification data is transmitted from a notifying apparatus to a notified apparatus, while others are kept from knowing the data.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An electronic certification system having a first apparatus and a second apparatus, the first apparatus being configured as a requester, the second apparatus being configured as a certificate issuer, the system comprising: the first apparatus including:
an encryptor configured to encrypt random number data by using a public key of the second apparatus and to generate encrypted random number data;
a data scrambler configured to perform a calculation that multiples, by original data, the encrypted random number data obtained by the encryptor, and to generate random number scrambled original data; and
a transmitter configured to transmit the random number scrambled original data obtained by the data scrambler to the second apparatus; and the second apparatus including:
a data adder configured to perform a calculation that multiples, by certified item data, the random number scrambled original data received from the first apparatus, and to generate random number scrambled original data having a certified item;
an encryptor configured to encrypt the random number scrambled original data having the certified item obtained by the data adder, using a private key of the second apparatus, and to generate certificate data; and
an issuer configured to issue the certificate data obtained by the encryptor to one of the first apparatus and another apparatus.

2. The electronic certification system according to claim 1, wherein one of the first apparatus and the another apparatus further includes:
a random number remover configured to perform a calculation that multiples the certificate data by an inverse number of the random number data, and to remove the random number data from the certificate data;
a decryptor configured to decrypt the data obtained by the random number remover, by using the public key of the second apparatus, and to obtain product data that is a multiplication of the original data and the certified item data; and
a data extractor configured to obtain certified item data by multiplying the product data by an inverse number of the original data.

3. The electronic certification system according to claim 1, wherein one of the first apparatus and the another apparatus is configured to obtain the certified item data, and one of the first apparatus and the another apparatus further includes:
a random number remover configured to perform a calculation that multiples the certificate data by the inverse number of the random number data, and to remove the random number data from the certificate data;
a decryptor configured to decrypt the data obtained by the random number remover, by using the public key of the second apparatus, and to obtain product data that is a multiplication of the original data and the certified item data; and
an original data extractor configured to multiply the product data by an inverse number of the certified item data, and to obtain the original data.

4. The electronic certification system according to claim 1, wherein, in the second apparatus, the encryptor encrypts the certified item data by using the private key of the second apparatus, and the second apparatus includes:
a transmitter configured to transmit, to one of the first apparatus and the another apparatus, one of the encrypted certified item data obtained by the encryptor and an inverse number of the encrypted certified item data, and wherein one of the first apparatus and the another apparatus includes:
a random number remover configured to perform a calculation that multiplies the certificate data by the inverse number of the random number data or the inverse number of the encrypted certified item data, and to obtain encrypted original data; and
an original data obtainer configured to decrypt the encrypted original data obtained by the random number remover, by using the public key of the second apparatus, and to obtain the original data.

5. The electronic certification system according to claim 1, wherein the certified item data includes time information.

6. The electronic certification system according to claim 1, wherein each process is performed while the original data is split into a plurality of spilt data sets.

7. A confidential communication system having a first apparatus and a second apparatus, the first apparatus being configured as a communication destination, the second apparatus being configured as a communication source, the system comprising: the first apparatus including:
an encryptor configured to encrypt random number data by using a public key of the second apparatus; and
a transmitter configured to transmit the encrypted random number data obtained by the encryptor to the second apparatus; the second apparatus including:
a calculator configured to perform a calculation that multiples notification data for confidential communication by the encrypted random number data received from the first apparatus;
an encryptor configured to encrypt the random number scrambled notification data obtained by the calculator, by using a private key of the second apparatus, and to obtain encrypted notification data; and
a transmitter configured to transmit the encrypted notification data generated by the encryptor to the first apparatus; and the first apparatus further including:
a random number remover configured to perform a calculation that multiplies the encrypted notification data received from the second apparatus by an inverse number of the random number data, and to remove the random number data from the encrypted notification data; and
a decryptor configured to obtain notification data by decrypting the data obtained by the random number remover, by using the public key of the second apparatus.

8. The confidential communication system according to claim 7, wherein each process is performed while the notification data is split into a plurality of spilt data sets.

9. An electronic certification method comprising: by a first apparatus configured as a requester,
encrypting random number data by using a public key of a second apparatus configured as a certificate issuer;
performing a calculation that multiples original data by the obtained encrypted random number data; and
delivering the obtained random number scrambled original data to the second apparatus; and, by the second apparatus,
performing a calculation that multiples the random number scrambled original data received from the first apparatus by certified item data;
encrypting the obtained random number scrambled original data having the certified item, by using a private key of the second apparatus; and
issuing the obtained certificate data to one of the first apparatus and another apparatus.

10. The electronic certification method according to claim 9 further comprising: by one of the first apparatus and the another apparatus,
performing a calculation that multiples the certificate data by an inverse number of the random number data, and removing the random number data from the certificate data;
decrypting the obtained data by using the public key of the second apparatus;
obtaining product data that is a multiplication of the original data and the certified item data; and
obtaining certified item data by multiplying the product data by an inverse number of the original data.

11. The electronic certification method according to claim 9 further comprising: by one of the first apparatus and the another apparatus,
obtaining the certified item data;
performing a calculation that multiples the certificate data by the inverse number of the random number data, and removing the random number data from the certificate data;
decrypting the obtained data by using the public key of the second apparatus;
obtaining product data that is a multiplication of the original data and the certified item data; and
multiplying the product data by an inverse number of the certified item data, and obtaining the original data.

12. The electronic certification method according to claim 9 further comprising: by the second apparatus,
encrypting the certified item data by using the private key of the second apparatus, and by one of the first apparatus and the another apparatus,
obtaining one of the obtained encrypted certified item data and an inverse number of the encrypted certified item data;
performing a calculation that multiplies the certificate data by the inverse number of the random number data or by the inverse number of the encrypted certified item data, and obtaining encrypted original data; and
decrypting the encrypted original data by using the public key of the second apparatus, and obtaining the original data.

13. The electronic certification method according to claim 9, wherein the certified item data includes time information.

14. The electronic certification method according to claim 9, wherein each process is performed while the original data is split into a plurality of spilt data sets.

15. A confidential communication method comprising: by a first apparatus configured as a communication destination,
encrypting random number data by using a public key of a second apparatus configured as a communication source; and
delivering the obtained encrypted random number data to the second apparatus; by the second apparatus,
performing a calculation that multiples notification data for confidential communication by the encrypted random number data received from the first apparatus;
encrypting the obtained random number scrambled notification data, by using a private key of the second apparatus, and obtaining encrypted notification data; and
delivering the encrypted notification data to the first apparatus; and by the first apparatus,
performing a calculation that multiplies the encrypted notification data received from the second apparatus by an inverse number of the random number data, and removing the random number data from the encrypted notification data; and
obtaining notification data by decrypting the obtained data by using the public key of the second apparatus.

16. The confidential communication method according to claim 15, wherein each process is performed while the notification data is split into a plurality of spilt data sets.
